(19) United States
(12) Patent Application Publication
(10) Pub. No.: US 2020/0283709 A1
(43) Pub. Date: Sep. 10, 2020

(54) METHOD FOR MODIFYING THE ORGANOLEPTIC PROPERTIES OF AN ALCOHOLIC BEVERAGE

(71) Applicant: Michael PAETZOLD, BORDEAUX (FR)

(72) Inventor: Michael PAETZOLD, BORDEAUX (FR)

(21) Appl. No.: 16/762,318

(22) PCT Filed: Nov. 26, 2018
(86) PCT No.: PCT/EP2018/082469

§ 371 Date: May 7, 2020

(30) Foreign Application Priority Data
Dec. 5, 2017 (FR) 1761634

(51) Int. Cl. C12G 3/07; C12H 1/22; B27M 3/08

(52) U.S. Cl. CPC C12G 3/07; B27M 3/08; C12H 1/22

(57) ABSTRACT

The invention relates to a method for modifying the organoleptic properties of an alcoholic beverage, characterised in that it comprises a step of ageing a piece of wood (10), a wood powder or a wood extract in order to remove the aromatic components from the piece of wood (10), the wood powder or the wood extract, and a short extraction step of the wood for limiting the extraction of tannic components, the ageing step being before or after the extraction step.

### BACKGROUND OF THE INVENTION

### Field of the Invention

This application relates to a method for modifying the organoleptic characteristics of an alcoholic beverage starting from an extraction of wood, as well as a piece of wood or a wood extract that is used for implementing said method.

### Description of the Related Art

According to a first vinification technique, wine is matured in an oakwood barrel.

According to one embodiment, a wooden barrel is made from stave wood that is cut up into oakwood lumber. After drying for several years, the stave wood is planed and crafted in such a way as to produce dowels, which are assembled in such a way as to form the wooden barrel. After it is shaped, the wooden barrel is subjected to heating called toasting. Depending on the intensity of the heating, certain aromas will develop more than others. The intensity of the heating is adjusted depending on the organoleptic characteristics that are desired for the wine.

During the maturing of the wine in a wooden barrel, which takes several months, the wood of the barrel diffuses into the wine the aromatic compounds that will supplement the aromas that are already present in the wine. It also diffuses polyphenols and tannins that modify the organoleptic characteristics of the wine. The maturing of wine in a wooden barrel makes it possible to obtain an input of aromas, tannins, and sweetness.

According to a second vinification technique, the wine is matured in a “neutral” vat, in general made of stainless steel. Wood chips (or any other piece of wood) that are greater in size than 2 mm are introduced into the vat to macerate in wine for a maceration period of one or more months. According to one method of production, these wood chips are obtained from scraps from cutting lumber into stave wood. Like the dowels, these wood chips are subjected to heating. Thus, like a wooden barrel, the wood chips diffuse aromatic compounds, polyphenols, and tannins in the wine and make it possible to obtain an input of aromas, tannins, and sweetness.

After the maceration phase, the wood chips are removed from the wine.

According to a drawback for the two techniques cited above, it is very difficult to modify a characteristic of wine, such as its silky, homogeneous, appearance, without adding sweetness, new tannins, and/or new aromas. However, for some wines, the input of sweetness, new tannins, and/or new aromas is not necessary, and is even detrimental to the desired organoleptic characteristics.

### SUMMARY OF THE INVENTION

The purpose of this invention is to eliminate the drawbacks of the prior art.

For this purpose, the invention has as its object a method for modifying the organoleptic properties of an alcoholic beverage, characterized in that it comprises an aging step of a piece of wood, a wood powder, or a wood extract whose purpose is to remove aromatic components from the piece of wood, the wood powder, or the wood extract, and a short extraction step of the wood whose purpose is to limit the extraction of tannic components, with the aging step being before or after the extraction step.

According to other characteristics:
The method comprises an intense heating step after the aging step;
During the heating step, the wood or the wood extract is heated at a temperature that is greater than or equal to 200° C. for a period of at least 25 minutes for the wood chips, at least 10 minutes for the wood powder, or at least one minute for the wood extract;
The extraction step is carried out in the alcoholic beverage;
The extraction step is carried out in an aqueous medium that is different from the alcoholic beverage, and then the thus produced wood extract is integrated into the alcoholic beverage;
The extraction step is a maceration with a period that is less than or equal to 1 hour;
The aging step is carried out by keeping the wood in contact with air and has a duration that makes it possible to modify the wood up to the core or over at least 3 mm of thickness starting from the surface of the wood.

### BRIEF DESCRIPTION OF THE DRAWINGS

Other characteristics and advantages will emerge from the following description of the invention, a description that is provided only by way of example, with regard to the accompanying drawings, among which:

FIG. 1 is a cutaway of a dowel in which short wooden sticks are cut up according to the invention,

FIG. 2 is a top view of a short stick that illustrates an embodiment of the invention,

FIG. 3 is a section of the short stick that can be seen in FIG. 2,

FIG. 4 is a section of a short stick that illustrates another embodiment of the invention,

FIG. 5 is a front view of a series of circular saws used for cutting out short sticks and machining grooves in the short sticks,

FIG. 6 is a diagram of a device that makes it possible to implement a first method for vinification or maturing a wine using a short stick according to the invention, and

FIG. 7 is a diagram of a device that makes it possible to implement a first method for vinification or maturing a wine using a short stick according to the invention.

### DESCRIPTION OF THE PREFERRED EMBODIMENTS

In a known method, a wine is characterized by its aromatic palette, the quantity and the quality of its tannins, and other characteristics. This set of characteristics is in general called the organoleptic characteristics of the wine.

During tasting, a wine can be perceived as very silky (impression provided by a velvety, smooth wine) or very rough (impression provided by a wine that has excessive acidity and an astringency). Below, the nature of the wine is defined as a chart ranging from very silky to very rough.

The purpose of this invention is to modify the nature of the wine or any other alcoholic beverage without input of sweetness, new tannins, and/or aromas. An alcoholic beverage is defined as any beverage that is fermented, macerated, distilled or that otherwise contains ethanol.

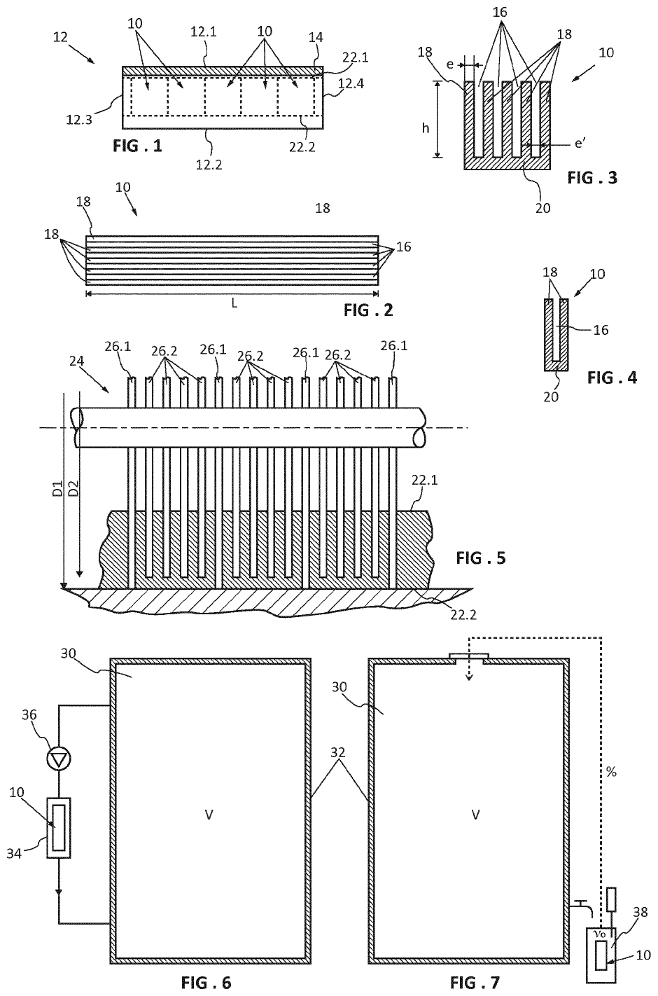

In FIG. 1, short sticks made of wood cut out into a dowel 12 of an oakwood barrel that has been used for maturing at least one wine were shown at 10.

The dowel 12 comprises an inside face 12.1, an outside face 12.2, and edges 12.3 and 12.4. A portion 14 of the dowel 12 that extends starting from the inside face 12.1 over a given depth on the order of 5 mm is altered by heating during the production of the wooden barrel and/or by the wine during the maturing of wine.

The short wooden sticks 10 are cut out from the altered part or parts 14 of the dowel 12.

To form a wooden barrel for maturing a wine, the dowels 12 are made from oakwood staves that are dried in the open air for a minimum period of 18 months. The dowels are heated and wetted to bend them and install the barrel hoops. After it is shaped, the wooden barrel undergoes a heating phase called toasting.

These heating cycles make possible the destructuring of the lignocellulosic material (or a fractionation of the lignin/polyphenol/polysaccharide complexes) and a fusion of surface parietal components.

Regardless of the method of production, each short stick 10 has an approximately parallelepiped shape that has an essentially constant section and a length L that is considerably greater than the other dimensions of its section.

Hereinafter, the longitudinal direction is parallel to the length of the short stick 10. A plane or a cross-section is perpendicular to the longitudinal direction.

Each short stick 10 has at least one groove 16 that is arranged between at least two wings 18, parallel to the longitudinal direction, connected by a base 20 in such a way that for a given cross-section, the short stick 10 has an essentially constant thickness of between 1 and 4 mm.

The fact of providing at least one groove 16 makes it possible to increase the contact surface between the wood and the wine for a given wood volume. The fact of having a constant thickness makes it possible to achieve uniform heating, on the surface and in the core, over the entire thickness of the short wooden stick 10.

Each short stick 10 has a rectangular or square cross-section that has a larger side that is less than 20 mm and a smaller side that is greater than 5 mm.

According to one embodiment that is illustrated by FIGS. 2 and 3, the short stick 10 has an approximately square cross-section, with one side of between 16 and 18 mm. It comprises multiple grooves 16, on the order of four, which separate five wings 18 that are connected by a base 20. Each wing 18 has a thickness e on the order of 2 mm, a height h on the order of 15 mm, and the groove has a thickness e′ that is essentially equal to e. The base has a thickness of between 2 and 3 mm.

The short stick has a length L of between 50 and 200 mm, preferably between 100 and 130 mm.

According to another embodiment that can be seen in FIG. 4, the short stick 10 has a U-shaped section and two wings 18 that are separated by a groove 16. As above, each wing 18 has a thickness e on the order of 2 mm, a height h on the order of 15 mm, and the groove has a thickness e′ that is essentially equal to e. The base has a thickness of between 2 and 3 mm. The short stick has a length of between 50 and 200 mm, preferably between 100 and 130 mm.

According to one method of production, each dowel 12 is machined in such a way as to form a wooden plate with two parallel faces 22.1 and 22.2, separated by a distance that is equal to one of the sides of the cross-section of the short sticks 10. Next, simultaneously, the short sticks 10 are cut out in the plate, and the grooves 16 are machined using a series 24 of circular saws that comprises the circular saws 26.1 with a first diameter D1, configured to separate the short sticks 10, and the circular saws 26.2 with a second diameter D2, less than the diameter D1, configured to machine the grooves 16.

This method of production makes it possible to produce, at a lower cost, the short sticks 10.

After their machining, the short sticks 10 are subjected to an intense heating. The wood of the short sticks 10 changes color and becomes dark chestnut brown.

According to one operating mode, the short sticks 10 are heated by convection, at a temperature of greater than 200° C., on the order of 230° C., for a period of at least 25 minutes or more according to the amount of wood and the furnace that is used.

At the end of this heating step, the short wooden sticks 10 are ready to be used to modify the organoleptic characteristics of a wine, in particular its nature.

The invention is not limited to this embodiment in the form of a short stick.

Thus, the piece of wood that is used can have various shapes.

In addition, it cannot be cut into a dowel of an oakwood barrel that has been used for maturing at least one wine but can originate from a piece of oakwood that has undergone an aging step.

By way of example, the piece of oakwood in which the piece of wood is cut out is subjected to a transformation that is analogous to that of a dowel of an oakwood barrel that has been used for maturing at least one wine.

For this purpose, the piece of wood is cut into oak logs and undergoes the following steps:
Biochemical maturation in the open air for a minimum period of 18 months,
Heating, by multiple stages, having a first step of destructuring the lignocellulosic material (or a fractionation of the lignin/polyphenol/polysaccharide complexes) and a second step of fusion of the surface parietal components,
Soaking in demineralized water,
Sterilization, and
Alternating of phases of biochemical maturation and drying in a hydroalcoholic acid solution for 3 years.

According to a special feature, the piece of wood is to have a low ellagitannin content.

The pieces of wood that are processed according to the invention can be used during the vinification, the making of a wine, and/or after the maturing of a wine in a wooden barrel.

According to a first technique, at least one short wooden stick 10 is put directly into contact with the wine by soaking for a period that is longer or shorter depending on the desired organoleptic characteristics.

As illustrated in FIG. 6, the wine 30 is stored in a vat 32 with a volume V. At least one short stick 10 is immersed in a supplementary tank 34 that has a volume that is significantly less than that of the vat, in which a stream of wine circulates that is sampled and returned to the vat using a pump 36.

According to a second technique that is illustrated by FIG. 7, the wine 30 is stored in a vat 32 with a volume V. At least one short stick 10 is immersed in a fraction of wine 38 that is sampled from the vat 32, with the fraction of wine 38 having a volume v₀ that is at least 100 times less than the volume V of the vat 32. This fraction of wine 38, in which the short stick 10 was macerated during a given period, is called a concentrate. The organoleptic characteristics of this concentrate are evaluated, and a certain percentage of this concentrate is reintroduced into the vat 32 depending on the organoleptic characteristics that are desired for the wine 30 in the vat 32 and the evaluated organoleptic characteristics of the concentrate. This second technique makes it possible to achieve a more specific processing.

Regardless of the technique that is used, it is noted that the short wooden stick or piece of wood 10 that is processed according to the invention is immersed in wine during a period of contact that does not exceed 1 hour, significantly less than the period of contact of the wood and the wine that is several months for the techniques of the prior art.

The method of the invention can be implemented at any time in the production of a wine, even after it has matured in a wooden barrel. In this latter case, it makes it possible to refine the nature of the wine.

The fact of putting into contact at least one short wooden stick or piece of wood 10 that is processed according to the invention with a wine for a short period (less than one hour) makes it possible to modify its organoleptic characteristics, in particular its nature. This contact with the wine provides more harmony and more elegance upon tasting in the mouth, as well as an enhanced perception of the tannic sensation. A wine that is processed according to the invention is perceived to be less vegetal, less bitter, and with less “tartness.”

Regardless of the embodiment, the wood undergoes a wood aging step that consists essentially in removing the aromatic components and the components connected with the input of sweetness over at least a certain thickness of the wood. According to an operating mode, this aging step is carried out by keeping the wood in contact with air. This aging step gradually modifies the wood from its surface to the core with a penetration speed of approximately 1 mm/year. The duration of the aging step is based on the dimensions of the wood that is to be processed. The thicker the wood, the longer the duration of the aging step. In the case of a wood powder that has a grain size on the order of 0.1 mm, the wood aging step is carried out by keeping the wood powder in contact with air for at least 18 days to bring about a modification of the wood up to the core of the wood. For wood chips that have a thickness on the order of 4 mm, it is advisable to provide a duration for the aging step on the order of 2 years. For the wood chips that have a larger thickness, it is necessary to bring about a modification of the wood over at least 3 mm of thickness starting from the surface, or a duration for the aging step that is greater than or equal to 3 years. In the case of wood chips that are cut out in a dowel from casks, the period that ranges from the cutting-out of the stave wood to the cutting-out of the dowel after the maturation of at least two wines (or 4 years) is sufficient to bring about this aging.

Regardless of the thickness of the wood, the duration of the aging step should make it possible to modify the wood up to the core of the wood or over at least 3 mm of thickness starting from the surface, knowing that the rate of penetration is approximately 1 mm per year.

The aging step can be carried out by keeping the wood static in contact with the air. However, the invention is not limited to this aging step. Thus, as described above, a fresh piece of wood can undergo a biochemical maturation step in the open air for a minimum period of 18 months, a heating step, a step of soaking in demineralized water, a sterilization step, and an alternating of phases of biochemical maturation and drying in hydroalcoholic acid solution for 3 years.

Regardless of the embodiment, the wood undergoes an extraction step whose purpose is to extract so-called structuring components that make it possible to modify the organoleptic characteristics of an alcoholic beverage, its nature in the case of wine, without input of sweetness, tannins, and/or aromas. These structuring components are extracted more quickly than the tannic components. According to an operating mode, this extraction step is carried out by maceration at ambient temperature of the wood during a period of less than 3 days. Beyond 3 days, the extraction of tannic components from wood is too great.

Generally, the duration of the extraction step by maceration at ambient temperature is less than or equal to 1 hour. This period can be modulated depending on the maceration conditions, in particular the temperature.

Of course, the invention is not limited to a maceration for the extraction. Other operating modes for the extraction could be considered from the time that this operating mode promotes the extraction of structuring components and limits the extraction of tannic components.

According to a first operating mode, the wood extraction step is carried out in the alcoholic beverage whose organoleptic properties are to be modified.

According to another operating mode, the wood extraction step is carried out in an aqueous medium (in water, for example) that is different from the alcoholic beverage, and the thus obtained extract is integrated into the alcoholic beverage whose organoleptic properties are to be modified.

Prior to its incorporation into the alcoholic beverage, the extract can be concentrated or dehydrated.

For certain alcoholic beverages, in addition to aging and extraction steps, the method comprises an intense heating step whose purpose is to heat the wood at a temperature that is greater than or equal to 200° C. for a period of at least 25 minutes for wood chips, at least 10 minutes for powder, or at least 1 minute for extracts. This heating step is always after the aging step, with the aging and heating steps always being before the incorporation of the wood extract into the alcoholic beverage.

This heating step makes it possible to complete the aging step. For wood that has been cut for more than about thirty years, this heating step is not necessary.

The method according to the invention makes it possible to remove the essentially aromatic components using the aging step and to prevent the input of tannic components using an extraction of short duration. Thus, the method makes it possible to integrate structuring components into the alcoholic beverage without input of sweetness, tannins, and/or aromas.

The various possible combinations for the method are in particular:
An aging step, a heating step, and then a step for extraction in the alcoholic beverage;
An aging step, a heating step, and then a step for extraction in an aqueous medium, and then a step for incorporating the wood extract into the alcoholic beverage;
An aging step, a step for extraction in an aqueous medium, a step for dehydrating the wood extract, a step for heating the dehydrated wood extract, and then a step for incorporating the dehydrated and heated wood extract;
A step for extraction in an aqueous medium, a step for dehydrating the wood extract, a step for aging the dehydrated wood extract, a step for heating the dehydrated and aged wood extract, and then a step for incorporating the dehydrated, aged, and heated wood extract.

1. Method for modifying the organoleptic properties of an alcoholic beverage, comprising an aging step of a chip, a wood powder, or a wood extract whose purpose is to remove aromatic components from the wood chip, the wood powder, or the wood extract, and a short extraction step of the wood whose purpose is to limit the extraction of tannic components, with the aging step being before or after the extraction step.

2. The method for modifying the organoleptic properties of an alcoholic beverage according to claim 1, further comprising an intense heating step after the aging step.

3. The method for modifying the organoleptic properties of an alcoholic beverage according to claim 2, wherein during the heating step, the wood or the wood extract is heated at a temperature that is greater than or equal to 200° C. for a period of at least 25 minutes for the wood chips, at least 10 minutes for the wood powder, and at least 1 minute for the wood extract.

4. The method for modifying the organoleptic properties of an alcoholic beverage according to claim 1, wherein the extraction step is carried out in the alcoholic beverage.

5. The method for modifying the organoleptic properties of an alcoholic beverage according to claim 1, wherein the extraction step is carried out in an aqueous medium that is different from the alcoholic beverage, and then the thus obtained wood extract is integrated into the alcoholic beverage.

6. The method for modifying the organoleptic properties of an alcoholic beverage according to claim 1, wherein the extraction step is a maceration with a duration that is less than or equal to 1 hour.

7. The method for modifying the organoleptic properties of an alcoholic beverage according to claim 1, wherein the aging step is carried out by keeping the wood in contact with air and has a duration that makes it possible to modify the wood up to the core or over at least 3 mm of thickness starting from the surface of the wood.

8. The method for modifying the organoleptic properties of an alcoholic beverage according to claim 1, wherein the piece of wood (10) is cut out in one part of a dowel (12) from an oakwood barrel that has been used for maturing at least one wine, with said dowel part not having been altered (14) by heating during the production of the wooden barrel and/or by the wine during the maturing of the wine.

9. The method for modifying the organoleptic properties of an alcoholic beverage according to claim 1, wherein the piece of wood (10) is cut out in the form of a short wooden stick, approximately parallelepiped, which has an approximately constant section, at least one groove (16) that is arranged between at least two wings (18), and an essentially constant thickness, ranging between 1 and 4 mm, in a given cross-section.

10. The method for modifying the organoleptic properties of an alcoholic beverage according to claim 9, wherein the short wooden stick (10) is cut out in a wooden plate, and the grooves (16) are machined simultaneously using a series (24) of circular saws that comprises circular saws (26.1) with a first diameter (D1), configured for separating the short wooden stick (10), and circular saws (26.2) with a second diameter (D2), less than the first diameter (D1), configured for machining the grooves (16).

11. The method for modifying the organoleptic properties of a wine according to claim 1, wherein with the wine (30) being stored in a vat (32) with a first volume (V), the method comprises the following steps:
Sampling a wine fraction (38) in the vat (32), with said wine fraction (38) having a second volume (v₀) that is at least 100 times less than the first volume (V),
Macerating at least one piece of wood (10) in said wine fraction (38) for a given period in such a way as to obtain a concentrate,
Evaluating the organoleptic characteristics of the concentrate, and
Reintroducing a percentage of the concentrate into the vat (32) depending on the desired organoleptic characteristics for the wine (30) that is stored in the vat (32) and the evaluated organoleptic characteristics of the concentrate.

12. Piece of wood (10) that is used for implementing the method for modifying the organoleptic characteristics of an alcoholic beverage according to claim 1, wherein the piece of wood is a short wooden stick (10) that has a length (L) of between 50 and 200 mm, a cross-section that is approximately constant and is rectangular or square, which has a larger side that is less than 20 mm and a smaller side that is greater than 5 mm, at least one groove (16) that is arranged between at least two wings (18) that are connected by a base (20), with the short wooden stick (10) having an essentially constant thickness, ranging between 1 and 4 mm, for a given cross-section.

13. The piece of wood (10) according to claim 12, wherein the short wooden stick (10) has a length of between 100 and 130 mm, an approximately square cross-section, with a side ranging between 16 and 18 mm, wings that have a thickness on the order of 2 mm, grooves that have a thickness on the order of 2 mm, and a base that has a thickness ranging between 2 and 3 mm.

14. Wood extract that is used for implementing the method for modifying the organoleptic characteristics of an alcoholic beverage according to claim 1, wherein the wood extract is produced starting from an aging step of a chip, a wood powder, or a wood extract whose purpose is to remove aromatic components from the piece of wood, the wood powder, or the wood extract, and a short wood extraction step whose purpose is to limit the extraction of tannic components, with the aging step being before or after the extraction step.

15. The method for modifying the organoleptic properties of an alcoholic beverage according to claim 2, wherein the extraction step is carried out in the alcoholic beverage.

16. The method for modifying the organoleptic properties of an alcoholic beverage according to claim 3, wherein the extraction step is carried out in the alcoholic beverage.

17. The method for modifying the organoleptic properties of an alcoholic beverage according to claim 2, wherein the extraction step is carried out in an aqueous medium that is different from the alcoholic beverage, and then the thus obtained wood extract is integrated into the alcoholic beverage.

18. The method for modifying the organoleptic properties of an alcoholic beverage according to claim 3, wherein the extraction step is carried out in an aqueous medium that is different from the alcoholic beverage, and then the thus obtained wood extract is integrated into the alcoholic beverage.

19. The method for modifying the organoleptic properties of an alcoholic beverage according to claim 2, wherein the extraction step is a maceration with a duration that is less than or equal to 1 hour.

20. The method for modifying the organoleptic properties of an alcoholic beverage according to claim 3, wherein the extraction step is a maceration with a duration that is less than or equal to 1 hour.
